(19) United States
(12) Patent Application Publication
(10) Pub. No.: US 2023/0002691 A1
(43) Pub. Date: Jan. 5, 2023

(54) CATALYTIC GASIFICATION PROCESS, CATALYST, USE OF THE CATALYST AND PROCESS FOR PREPARING THE CATALYST

(71) Applicants: PETRÓLEO BRASILEIRO S.A. - PETROBRAS, Rio de Janeiro (BR); UNIVERSIDADE FEDERAL DO RIO DE JANEIRO - UFRJ, Rio de Janeiro (BR)

(72) Inventors: Vivian PASSOS DE SOUZA, Rio de Janeiro (BR); Amanda DE ALMEIDA DUMANI DOS SANTOS, Rio de Janeiro (BR); Maira ANDRADE RODRIGUES, Rio de Janeiro (BR); Victor TEIXEIRA DA SILVA, Rio de Janeiro (BR)

(73) Assignees: PETRÓLEO BRASILEIRO S.A. - PETROBRAS, Rio de Janeiro (BR); UNIVERSIDADE FEDERAL DO RIO DE JANEIRO - UFRJ, Rio de Janeiro (BR)

(21) Appl. No.: 17/779,941

(22) PCT Filed: Nov. 17, 2020
(86) PCT No.: PCT/BR2020/050478

§ 371 Date: May 25, 2022

(30) Foreign Application Priority Data
Nov. 26, 2019 (BR) 10 2019 024932 3

(51) Int. Cl. C10J 3/46; C01B 3/02; B01J 23/745; B01J 21/08; B01J 35/02; B01J 37/04; B01J 37/02; B01J 37/08; C10J 3/48; C10J 3/54

(52) U.S. Cl. CPC C10J 3/463; C01B 3/02; B01J 23/745; B01J 21/08; B01J 35/026; B01J 37/04; B01J 37/0221; B01J 37/0236; B01J 37/088; C10J 3/482; C10J 3/54; C10J 2300/0986

(57) ABSTRACT

The present invention relates to a catalyst to be applied to the process of gasification of coke or coal, individually or in mixture, and to the process of preparing said catalyst, which is useful in obtaining higher levels of hydrogen and carbon monoxide, which allows the conversion of coke into by-products of higher added value (hydrogen-rich syngas). The present invention also addresses to a process for converting petroleum coke by using a catalyst according to the present invention.

### FIELD OF THE INVENTION

The present invention relates to a process of catalytic gasification of coke or coal, individually or in a mixture. The gasification process uses a catalyst that allows the conversion of coke into by-products of higher added value (hydrogen-rich syngas).

The present invention also relates to the process of obtaining said catalyst to be applied in the catalytic conversion process of petroleum coke and to the catalyst itself.

### DESCRIPTION OF THE STATE OF THE ART

It is common knowledge that oil is largely responsible for the industrial development of the early 19^{th} century, being the main source of energy on the planet until the present day. The fact that it is an exhaustible resource, allied to its important economic value, makes this fuel an element that causes major geopolitical and socioeconomic changes around the world.

In general, it is possible to describe petroleum as an oily and flammable substance, found underground at various depths. It consists mainly of a complex combination of hydrocarbons, mostly aliphatic, acyclic, alicyclic and aromatic hydrocarbons.

In the way it is extracted from the deposits, it has practically no application, making it useful only after being subjected to a process of fractionation or separation of its components, which is done in refineries, for the maximum use of its energy potential.

From oil refining, hydrocarbons are separated by distillation, and their impurities are removed in other processes, so that various products can be extracted, including: diesel, gasoline, naphtha, kerosene, asphalt, lubricants, paraffins, liquefied petroleum gas, solvents, plastics and polymers in general, tar and coke, more precisely petroleum coke, the main target of the catalyst described in this patent.

Petroleum coke consists of polymer chains with high molecular weights and high concentrations of carbon. Although the coke product is considered a low added value by-product, it can have some value, depending on its degree of purity, with a distinction between Metallurgical Grade Coke, used in iron and steel metallurgy, and Anode Grade, used as raw material in the manufacture of anodes for the production of aluminum or titanium dioxide.

Currently, the petroleum coke produced in the world is consumed in the form of fuel, and the main consumers are the oil refineries themselves, which preferentially use a fuel of low commercial value internally in their furnaces, maximizing the production and commercialization of other higher value products.

The petroleum coke, considered a solid fuel, has a high calorific value, a low ash content, low acquisition cost, low volatile material content, high sulfur content, ash containing heavy metals and low combustion efficiency.

It should be emphasized that petroleum coke comes from delayed coking, which is a process of thermal cracking of low added value oil streams (high density, rich in sulfur and impurities). The property of the coke generated depends on the origin of the oil and the operating conditions, and may present, in its final composition, a high amount of sulfur, low volatile content, in addition to increased viscosity.

Thus, due to its particular characteristics, petroleum coke is considered an interesting alternative to the use of coal. Its wide availability in oil refineries makes it a viable and low-cost substitute, which gives rise to the production of gas, hydrogen, methane and electricity by means of its gasification.

In turn, the gasification can be defined as the conversion of organic matter into gaseous products, by means of thermochemical reactions, involving steam, air, or oxygen, in amounts lower than the stoichiometric one (theoretical minimum for combustion).

Regardless of the nature of the load, the main elements that make up the mixture of hydrocarbons, carbon, hydrogen, oxygen and sulfur, are converted into the thermodynamically stable species that are: carbon monoxide, carbon dioxide, hydrogen, water, methane, hydrogen sulfide and carbonyl sulfide, whose proportions vary according to process conditions, particularly whether it is air or oxygen that is used in the oxidation.

Thus, the gasification allows converting hydrocarbons that cannot be vaporized, with the rupture of carbon-carbon bonds, which gives rise to the presence of a single resulting hydrocarbon, methane.

The most common raw materials for the gasification process are coal, oil and its residues, natural gas, biomass or mixtures of the same. The products obtained from the syngas are used in various applications such as, for example, power generation, hydrogen production, methanol production and liquid fuel synthesis.

In this way, the syngas obtained from the gasification of coal, of petroleum coke, of refinery residues normally presents in its composition 25-30% H₂ (v/v), 30-60% CO (v/v), 5-15% CO₂ (v/v) and 2-3% H₂O (v/v). Lower levels of CH₄, H₂S, N₂, NH₃, HCN, Ar, COS, Ni and Fe are also found. The amount and composition of the gases produced are differently related to the characteristics of the raw material used.

For the reaction to occur, typical processing temperatures are between 1600° C. to 1350° C. and pressures can reach 150 kgf/cm² (14.710 MPa). The basic reactions of the processes are:

$${C}_{n} {H}_{m} + \frac{n}{2} {O}_{2} ⇔ n CO + \frac{m}{2} {H}_{2} \qquad ( 1 )$$

$${C}_{n} {H}_{m} + {n H}_{2} O ⇔ n CO + ( \frac{m}{2} + n ) {H}_{2} \qquad ( 2 )$$

$${C}_{n} {H}_{m} + {n O}_{2} ⇔ {n CO}_{2} + \frac{m}{2} {H}_{2} \qquad ( 3 )$$

From this context, it is possible to note that the minimum amount of oxygen needed for the reaction to occur is indicated by equation (1), 0.5 kmol/h of oxygen for every 1 kmol/h of carbon.

Carbon monoxide and hydrogen are the main products until all the hydrocarbon is converted; only then will carbon dioxide and water be formed from additional oxygen provided. However, the sequence of reactions still remains uncertain. Some authors believe that CO₂ and H₂O are the primary products of the reaction.

To prevent uncontrolled temperature rise, sometimes steam is added, reacting endothermally with the hydrocarbons, according to equation (2). This leads to the formation of more hydrogen than expected by equation (1).

The proportion of components that will remain in the mixture is determined by equilibrium, which includes water displacement (5), steam reform (4) and reactions from hydrogen sulfide to carbonyl sulfide (6), in addition to carbon monoxide oxidation reactions (7) and methane dry reform (8), as follows:

$${C}_{n} {H}_{m} + {n H}_{2} O ⇔ ( n + m / 2 ) {H}_{2} + n CO Δ H298 > 0 \qquad ( 4 )$$

$$CO + {H}_{2} O ⇔ {H}_{2} + {CO}_{2} ΔH298 = - 41 kJ / mol \qquad ( 5 )$$

$${H}_{2} S + {CO}_{2} ⇔ {H}_{2} O + CO S \qquad ( 6 )$$

$$CO + \frac{1}{2} {O}_{2} ⇔ {CO}_{2} \qquad ( 7 )$$

$${CH}_{4} + {CO}_{2} ⇔ 2 CO + 2 {H}_{2} \qquad ( 8 )$$

Equilibrium is established in the reactor between 1500 and 1350° C. Below 900° C., the proximity to equilibrium is only reached with long residence times or with the use of a catalyst. The use of catalyst is not commercially applied due to soot formation.

Thus, oil residues and in particular petroleum coke have become a promising raw material for the gasification process, mainly due to its wide availability in oil refineries. As main characteristics, petroleum coke, when compared to coal, is less reactive, has lower amounts of carbon and low amounts of volatile materials, which leads to the need for high temperatures so that it can be gasified, between 1400 and 1500° C. Furthermore, due to the high sulfur contents, it is necessary to take an extra step to remove unwanted compounds, such as H₂S, COS and S₂.

In order to improve and optimize the gasification process, there are several strategies to be considered, among which it is possible to mention: air separation via membranes, new gasifier configurations, hot gas purification, new solvents, membranes to increase conversion in the shift reaction, hydrogen separation and application of catalysts in the process. Following this line of reasoning, the search for new catalysts may allow operation in milder conditions and/or with less formation of by-products, even reducing the temperature and energy consumption of the reaction, which results in an increase in the efficiency of the process.

Related literature describes that increasing the operating temperature increases the conversion of coke with CO₂ being the gasifying agent and leads to a reduction in the reaction time. Thus, the higher the temperature, the shorter the time required for the conversion of petroleum coke into gaseous products. Furthermore, the conversion rate increases with the increase in conversion, followed by a decrease.

Such reaction behavior observed in the gasification of coke with CO₂ is due to the fact that the temperature influences the graphitization process of petroleum coke during the gasification. In this context, it is worth to note that coke has high crystallinity and high structural organization when compared to coal, which are the ideal conditions for the formation of graphitic carbon as the temperature is increased.

Another point described in the specialized literature addresses to the influence of lignin on the gasification of petroleum coke. Lignin has high reactivity, which is due to the presence of alkaline species and high surface area. Said description points to the fact that the mixture of coke with lignin provides an optimization in the reactivity of coke, since in the grinding step it promotes an intimate contact between the species and, thus, the proximity of the alkaline species present in the lignin would be able to accelerate the gasification of petroleum coke.

With regard to patent literature, document US20150299588 describes the gasification reaction of coke with a catalyst impregnated in coal, in the presence of steam. The proposed catalyst consists of coal and potassium which, in a 1:1 ratio with coke, present a conversion of 88.4%. The reaction temperatures ranged from 700° C. to 900° C., in an argon atmosphere.

Document US20070083072 describes alkali metal catalysts for the coke gasification process. The catalysts are chosen from among the following species: Na₂CO₃, K₂CO₃, Rb₂CO₃, LiCO₃, CsCO₃, NaOH, KOH, RbOH, or CsOH, the coke being previously impregnated with a mixture of fresh and recovered solutions. The reaction is carried out with a temperature range from 580° C. to 816° C. The conversion reaches up to 97%, producing methane, carbon dioxide, carbon monoxide and hydrogen, the latter two being recycled in the process.

Document U.S. Pat. No. 6,585,883 addresses to the removal or reduction of coke in fluidized bed coking units. In this process, there are suggested oxide catalysts, alkoxylated or not with cerium, titanium and zirconium; cobalt, vanadium and silver oxides; metal carbonates, alkali metal and alkaline earth metal hydroxides; transition metal oxides of group VIII, mixtures of cerium vanadium oxide and potassium chloride or Cu—K—V—Cl catalysts or mixtures of the same, these solutions being previously impregnated in the coke. In this description, the reaction takes place at 500° C. to 700° C.

Document US20090165380 describes the gasification of coke with steam and a catalyst consisting of the combination of alkali metal hydroxide and one or more additional alkali metals, the catalyst being impregnated in the coke producing methane, hydrogen, carbon monoxide and other larger hydrocarbons. Coke gasification is carried out at 700° C.

Document CN108587687 discloses a method of gasification of petroleum coke by means of the use of a catalyst that comprises a mechanical mixing, immersion or direct spraying of magnesium-based catalysts, among which can be cited: MgO, MgCl₂, MgSO₄, and Mg(NO₃)₂.

In an additional way, document CN108641752 addresses to a method of optimizing the petroleum coke gasification reaction by means of catalysts: CaO, ZrO₂, Ba₂TiO₄, Li₂O, Li₂ZrO₃, Li₂SiO₃, Li₄SiO₄, which considerably increase the reaction rate of gasification and reduce the time required for this reaction.

From the disclosure, it is possible to note that the state of the art describes catalysts with the function of improving and optimizing the process in practice, but all examples present a step prior to the reaction in which the catalytic phase must be mixed with coke or impregnated in the same, or still impregnated in coal and then having the mixture of this with the coke, being necessary to repeat this step since the material must be resupplied to the process with the consumption of the coke.

Thus, it still remains to be described a catalyst capable of optimizing the process, without the need of carrying out the previous mixing phase or the coke impregnation phase to form the catalyst with each new coke supply; in this way, it is intended to disclose a catalyst in the traditional description that is not consumed with the coke and does not need to be resupplied in high relation with the same, but only the losses to be replaced, which reduces the number of steps and consequently the cost of the process.

In order to solve this issue, the present invention presents catalysts capable of optimizing the coke gasification process, reducing the cost by eliminating a coke pre-processing step to introduce the catalytic function and employing metals and supports of low cost. The elimination of the mentioned step refers to the fact that it is not necessary to mix the catalyst with coke or previously impregnate the catalyst in the same. It should further be emphasized that the process described in the present application gives rise to a high added value syngas, with a high concentration of hydrogen at very low processing costs, compared to the processes currently described.

### BRIEF DESCRIPTION OF THE INVENTION

The present invention relates to a catalyst for the conversion of organic matter, in particular petroleum coke, into gaseous products (gasification) by means of thermochemical reactions, involving steam, air or oxygen in amounts lower than the stoichiometric one. Regardless of the nature of the load, the main converting elements are carbon monoxide, carbon dioxide, hydrogen, water, methane, hydrogen sulfide, and carbonyl sulfide.

According to one aspect of the present invention, three catalysts are suggested, Fe/SiO₂—NO₃, derived from a nitrate, Fe/SiO₂—Cl, which is originated from a chloride, or Fe/SiO₂—SO₄, derived from of a sulfate. The invention proposes the preferential use of the Fe/SiO₂—Cl catalyst, which reached the total conversion in 4 hours of reaction, compared to the 6 hours necessary in the thermal gasification and in the reactions carried out using the catalysts Fe/SiO₂—NO₃ and Fe/SiO₂—SO₄.

According to the same aspect, the Fe/SiO₂—Cl catalyst reduces the reaction time at the same temperature, in relation to the purely thermal reaction, without the presence of a catalyst. The application of said catalyst gives rise to higher levels of H₂, promoting the conversion of petroleum coke into a by-product of higher added value (hydrogen-rich syngas), when compared to the state of the art.

### BRIEF DESCRIPTION OF DRAWINGS

The present invention will be described in more detail below, with reference to the attached figures which, in a schematic manner and not limiting the inventive scope, represent examples of its embodiment. In the drawings, there are:

FIG. 1 illustrates the conversion of petroleum coke as a function of time in thermal gasification and catalytic gasification at 800° C. using Fe/SiO₂ catalysts prepared from chloride, nitrate and sulfate.

FIG. 2 illustrates the molar composition of the gasifier output stream (on a water and nitrogen free basis) in the test conducted at 800° C. with the Fe/SiO₂—Cl catalyst.

FIG. 3 illustrates a molar composition of the gasifier output stream (with water and nitrogen free base) at 800, 750 and 700° C. with the Fe/SiO₂—Cl catalyst.

### DETAILED DESCRIPTION OF THE INVENTION

The present invention addresses to a catalytic gasification process of petroleum coke, coal or a mixture of the same, in order to generate hydrogen-rich syngas. The use of the catalyst provides milder conditions for processing the mentioned loads. Furthermore, the catalyst required in the present invention can be supplied together with the material to be processed, without the need for an impregnation step in the coke or previous mixing with coke or other materials.

The catalytic gasification process proposed in the present invention is carried out by means of the following steps:
a) loading the reactor with a catalyst, an inert material or a mixture of both;
b) fluidizing the bed loaded in step (a), at room temperature, in an air flow rate of 10 Nl·min⁻¹;
c) heating the bed fluidized in step (b), from room temperature to 800° C., at a rate of 20° C.·min⁻¹;
d) starting the intake of steam to the system heated in step (c);
e) starting the intake of petroleum coke after reaching the gasification temperature, the stabilization of the temperature of the bed and the system;
f) injecting the gas coming from the gasifier from step (e) into the chromatograph;
g) cooling the system under an air stream;
h) unloading the bed;
i) weighing the bed unloaded in step (h), the cyclones and the filters;
j) carrying out the mass balance of the unit.

In one aspect of the invention, the reactor bed is loaded with 1 kg of silica and 1 kg of catalyst, to carry out the catalytic gasification process of petroleum coke or coal. On the contrary, in a thermal gasification, the reactor would be loaded with 2 kg of silica, this material being inert.

In another aspect of the invention, it should be emphasized that, after fluidizing the bed, the temperature of 500° C. is reached, starting the intake of steam to the system, in which the liquid pump is calibrated for a supply of 5 ml·min⁻¹.

In another aspect, when the gasification temperature in the system is reached, there occurs the bed stabilization and the intake of petroleum coke at a rate of 0.366 kg·h⁻¹.

Still in an additional aspect, it should be emphasized that, five minutes after the start of solids supply, the gas from the gasifier was injected into the in-line chromatograph in order to determine its composition. Samples of the gas stream were injected every thirty minutes. Once the entire coke mass was supplied, the injections continued until the presence of CO and H₂ products was no longer detected, indicating the end of gasification.

When the gasification is ended and the room temperature reached, the bed is unloaded, followed by weighing the unloaded bed, the cyclones and the filters. Weighing is performed to determine whether there is a drag of particles from the bed, from petroleum coke or coal, depending on the case.

Regarding the aspect of the catalytic gasification process, it should be emphasized that said process gives rise to a hydrogen-rich syngas.

In yet another aspect of the catalytic gasification process, said process allows the reaction to occur under mild conditions and with higher conversion rates.

In addition to said aspect, the catalyst is supplied to the system without the need for impregnation in coke, coal or other similar material and without previous mixing with the load.

The second variation of the present invention addresses to a process for preparing a catalyst for catalytic gasification, described in several related aspects, among which the following preparation steps are included:
a) weighing 100 g of the support (quartz sand);
b) weighing the iron salt so as to have a desired iron content % (w/w);
c) adding 150 ml of water to the iron salt;
d) adding the prepared solution to the quartz sand;
e) allowing to stand for 16 hours;
f) evaporating the solution slowly;
g) drying in an oven at 100° C./16 hours;
h) calcinating at 550° C./5 hours.

In this variation, the catalysts were prepared by the slurry method, in which a determined mass of support, together with a solution, which makes up a desired concentration of the metal, are mixed forming a suspension. The solution with the suspension formed is allowed to stand and then dried and calcined.

In all variations of the present invention, the raw material used to obtain a hydrogen-rich syngas is, preferably, petroleum coke, in a maximum particle size of 177 μm. However, it is possible that the catalyst is used for the gasification of coal.

The catalyst mentioned in the previous variations of this invention is also required as an innovative product. In this way, the obtained catalyst for catalytic gasification comprises:
a) a support, preferably quartz sand;
b) a transition metal of group VIII;
c) the calcination of the narrated compounds at 550° C./5 hours.

It should be emphasized that, in this third variation of the invention, the catalyst for catalytic gasification comprises a transition metal of group VIII, namely iron. There are three forms of catalyst required in this invention, FeSiO₂—Cl, FeSiO₂—NO₃ and the third species, FeSiO₂—SO₄.

Among the species mentioned, FeSiO₂—Cl showed a reduction in time for conversion and increased the levels of CO₂ and H₂ in the reaction, compared to the thermal conversion. Thus, the catalyst for catalytic gasification FeSiO₂—Cl allows catalytic gasification to occur under milder conditions and with higher rates of conversion of petroleum coke and by similarity to coal.

In another way, the catalyst for catalytic gasification further has an additional advantage, since it is supplied to the system without the need for impregnation in coke, coal or other similar material and without the need for previous mixing with the load, reducing the processing steps, the processing time and the energy expenditure.

Therefore, the use of the catalyst for catalytic gasification, optimizes and improves the catalytic gasification process of petroleum coke or coal, giving rise to a hydrogen-rich syngas and of high added value. Additionally, it is a low-cost catalyst due to the materials used and the preparation method.

### Examples

As can be seen in the performed tests, the catalysts were prepared by the slurry method, which consists of adding a solution to a determined support mass with a desired concentration of the metal. The formed suspension is allowed to stand and then dried and calcined. The steps for preparation were:
a) weighing 100 g of the support (quartz sand);
b) weighing the iron salt to a desired iron content % (w/w);
c) adding 150 ml of water to the iron salt;
d) adding the prepared solution to the quartz sand;
e) allowing to stand for 16 hours;
f) evaporating the solution slowly;
g) drying in an oven at 100° C./16 hours;
h) calcinating at 550° C. for 5 hours.

The coke used in the tests was ground and subjected to a granulometric classification using a set of sieves, by having collected and stored the fraction with a maximum particle size of 177 μm. Table 1 addresses to the composition of the various catalysts prepared, determined by X-ray fluorescence (FRX).

TABLE 1
Composition of several prepared catalysts obtained by FRX.

| Fe Source | SiO₂ (% w/w) | Fe₂O₃ (% w/w) | Fe (% w/w) |
|---|---|---|---|
| Fe(NO₃)₃•9H₂O | 87.8 | 12.2 | 8.54 |
| FeCl₂•4H₂O | 92.9 | 7.1 | 4.97 |
| Fe₂(SO₄)₃•xH₂O | 96.4 | 3.6 | 2.52 |

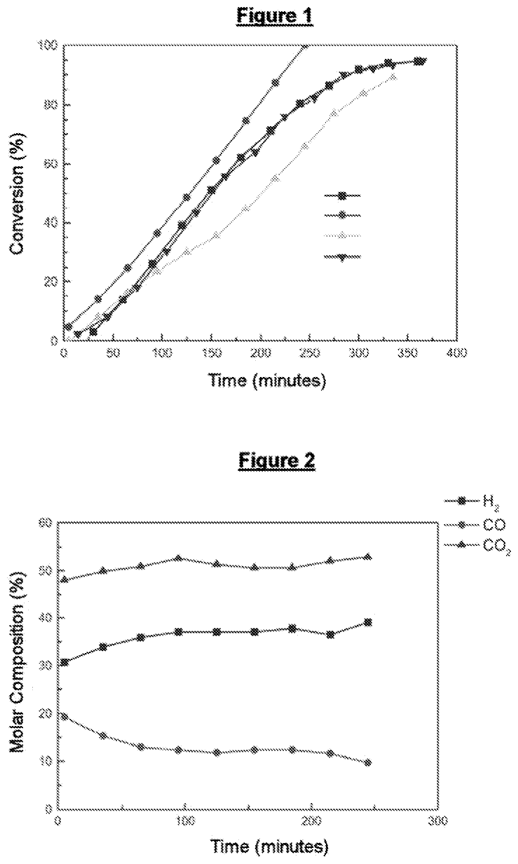

FIG. 1 demonstrates the conversion of petroleum coke as a function of gasification time, at a temperature of 800° C., when Fe/SiO₂ catalysts prepared from the use of chloride, sulfate and nitrate were used. For comparative purposes, the coke conversion curve obtained for thermal gasification, without the presence of catalyst, was included.

Blank tests and tests performed to test the conversion effectiveness of each catalyst were carried out by testing the following protocol:
a) Loading of the reactor bed, which may consist of 2 kg of silica (thermal gasification test) or 1 kg of silica and 1 kg of catalyst (catalytic gasification test);
b) Fluidization of the bed, at room temperature, using an air flow rate of 10 Nl·min⁻¹;
c) Heating of the bed, from room temperature to 800° C. using a rate of 20° C.·min⁻¹;
d) When the temperature of 500° C. was reached, the intake of steam to the system was started, and the liquid pump was calibrated for a supply of 5 mL·min⁻¹;
e) When the desired gasification temperature was reached, the stabilization was awaited. As soon as the bed temperature stabilized, the intake of petroleum coke was started at a rate of 0.366 kg·h⁻¹;
f) Five minutes after the start of solids supply, the gas from the gasifier was injected into the in-line chromatograph in order to determine its composition. Samples of the gas stream were injected every thirty minutes. Once the entire coke mass had been supplied, the injections continued until the presence of CO and H₂ products was no longer detected, indicating the end of gasification;
g) The system was cooled under an air stream and, once reached room temperature, the bed was unloaded and weighed. The cyclones and filters were also weighed to determine whether particles had been dragged from the bed or from the petroleum coke, thus closing the mass balance of the unit.

After the performed tests, it was possible to observe that the Fe/SiO₂ catalyst prepared from sulfate presented a performance similar to that observed in the thermal gasification. This result can be explained if it is considered that the content of iron incorporated into the silica, when sulfate was used as a source of the metal, was below the others. Such information can be corroborated by Table 1.

In the case of the catalyst prepared using nitrate as a source of iron, the incorporated content was above the other two, but also in this case, there was no significant improvement in the conversion of petroleum coke, compared to thermal gasification. In particular, the catalyst prepared from the nitrate showed a similar performance to the catalyst prepared from the sulfate until about 100 minutes, when a decrease in performance started, even with respect to thermal gasification.

The use of the Fe/SiO₂—Cl catalyst seems to have influenced the gasification kinetics of petroleum coke, since the total conversion was reached in 4 hours of reaction, compared to the 6 hours necessary in the thermal gasification and in the reactions carried out by using Fe/SiO₂—NO₃ and Fe/SiO₂—SO₄ catalysts.

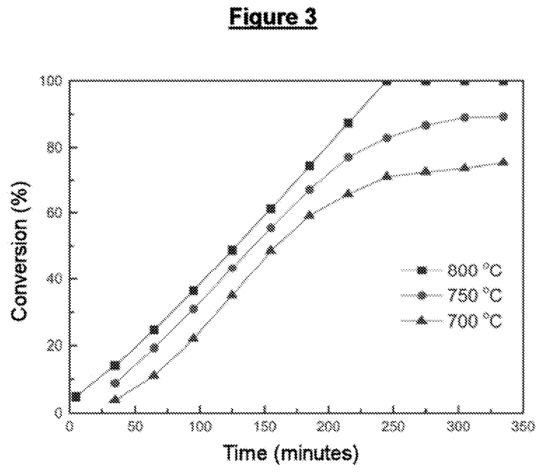

FIG. 2 shows the molar composition of the gasifier output stream (on a water and nitrogen-free basis) in the test conducted at 800° C. with the FeSiO₂—Cl catalyst. In the experiment using the Fe/SiO₂—Cl catalyst, higher contents of CO₂ and H₂ were obtained, as shown in FIG. 2. This result suggests that, in addition to being effective in reducing the total gasification time, this catalyst greatly promoted the reaction of gas-water displacement, thus increasing the production of hydrogen.

As can be seen in FIG. 3, there is the molar composition of the gasifier output stream (on a water and nitrogen-free basis) in the test conducted at 800, 750 and 700° C. Such data demonstrate that, in the additional tests referenced in FIG. 3, the conversion is reduced at lower temperatures and there is also a progressive increase in the gasification time to reach the final conversion. On the other hand, the conversion observed at 750° C. is close to the purely thermal conversion, without the presence of catalyst, as shown in FIG. 1. Accordingly, it can be noted that in the presence of the catalyst object of this innovation, lower temperatures are required to achieve conversions equal to those of the purely thermal reaction, making the whole process less energy intensive.

It should be noted that, although the present invention has been described in relation to the attached drawings, it may undergo modifications and adaptations by technicians skilled on the subject, depending on the specific situation, but provided that it is within the inventive scope defined herein.

1. A CATALYTIC GASIFICATION PROCESS, characterized in that it comprises the following steps:
a) loading the reactor bed;
b) fluidizing the bed loaded in step (a), at room temperature, in an air flow rate of 10 Nl·min⁻¹;
c) heating the bed fluidized in step (b), from room temperature to 800° C., at a rate of 20° C.·min⁻¹;
d) starting the intake of steam to the system heated in step (c);
e) starting the intake of petroleum coke after reaching the gasification temperature, the stabilization of the temperature of the bed and the system;
f) injecting the gas coming from the gasifier from step (e) into the chromatograph;
g) cooling the system under an air stream;
h) unloading the bed;
i) weighing the bed unloaded in step (g), the cyclones and the filters;
j) carrying out the mass balance of the unit.

2. THE CATALYTIC GASIFICATION PROCESS according to claim 1, characterized in that the reactor bed is loaded with mixtures of catalyst and inert material in proportions of 10:90, wherein the proportion of the mixture preferably chosen is 50:50, of silica and catalyst, when catalytic gasification of petroleum coke, coal or a mixture of the same is carried out.

3. THE CATALYTIC GASIFICATION PROCESS according to claim 1, characterized in that after the temperature of 300 to 700° C., preferably 500° C., is reached, the intake of steam begins with the liquid pump being calibrated for a supply of 5 ml·min⁻¹ or compatible with the size of the piece of equipment to be used.

4. THE CATALYTIC GASIFICATION PROCESS according to claim 1, characterized in that after the gasification temperature is reached, there occurs the bed stabilization and the intake of petroleum coke at a rate of 0.366 kg·h⁻¹ or compatible with the piece of equipment to be used and the mass of raw material.

5. THE CATALYTIC GASIFICATION PROCESS according to claim 1, characterized in that said process gives rise to a hydrogen-rich syngas, of high added value.

6. THE CATALYTIC GASIFICATION PROCESS according to claim 1, characterized in that said process allows the reaction to occur under mild conditions and with higher conversion rates.

7. THE CATALYTIC GASIFICATION PROCESS according to claim 1, characterized in that the catalyst is supplied to the process without the need for a previous impregnation step or without the need for a previous mixing with the load.

8. A PROCESS FOR PREPARING A CATALYST FOR CATALYTIC GASIFICATION, characterized in that the following preparation steps are carried out:
a) weighing 100 g of the support (quartz sand);
b) weighing iron salt so as to have a desired iron content % (w/w);
c) adding 150 ml of water to the iron salt;
d) adding the prepared solution to the quartz sand;
e) allowing to stand for 16 hours;
f) evaporating the solution slowly;
g) drying in an oven at 100° C./16 hours;
h) calcinating at 550° C./5 hours.

9. THE PROCESS FOR PREPARING A CATALYST FOR CATALYTIC GASIFICATION according to claim 8, characterized in that the catalysts were prepared by the slurry method.

10. THE PROCESS FOR PREPARING A CATALYST FOR CATALYTIC GASIFICATION according to claim 8, characterized in that the catalysts were prepared at a determined support mass with a solution with the desired concentration of the metal.

11. THE PROCESS FOR PREPARING A CATALYST FOR CATALYTIC GASIFICATION according to claim 8, characterized in that the catalysts were prepared from a suspension formed and allowed to stand to then be dried and calcined.

12. THE PROCESS FOR PREPARING A CATALYST FOR CATALYTIC GASIFICATION according to claim 8, characterized in that the raw material used is, preferably, petroleum coke, wherein the maximum particle size is 177 μm.

13. A CATALYST FOR CATALYTIC GASIFICATION, obtained by the process defined in claim 8, characterized in that it comprises:
a) a support, preferably quartz sand;
b) a transition metal of group VIII;
c) the calcination of the described compounds at 400 to 700° C., preferably at 550° C., with a time ranging from 2 to 10 hours and preferably within 5 hours.

14. THE CATALYST FOR CATALYTIC GASIFICATION according to claim 13, characterized in that the transition metal of group VIII comprises iron.

15. THE CATALYST FOR CATALYTIC GASIFICATION according to claim 13, characterized in that the catalyst can be of the following species: Fe/SiO₂—NO₃ and Fe/NO₃—SO₄.

16. THE CATALYST FOR CATALYTIC GASIFICATION according to claim 13, characterized in that it is used for the catalytic gasification of petroleum coke, coal and a mixture of both, wherein the raw material that is preferably used is petroleum coke.

17. THE CATALYST FOR CATALYTIC GASIFICATION according to claim 13, characterized in that it allows catalytic gasification to occur under milder conditions and with higher conversion rates of petroleum coke and coal.

18. THE CATALYST FOR CATALYTIC GASIFICATION according to claim 13, characterized in that the catalyst is supplied to the process without the need for a previous impregnation step or without the need for a previous mixing with the load.

19. A USE OF THE CATALYST, as defined in claim 13, characterized in that it is for the optimization and improvement of the catalytic gasification process of petroleum coke, coal or a mixture of both, wherein the raw material that is preferably used is coke.

20. THE USE OF THE CATALYST according to claim 19, characterized in that it results in a hydrogen-rich syngas and with high added value.
